(19) United States
(12) Patent Application Publication
(10) Pub. No.: US 2002/0039054 A1
(43) Pub. Date: Apr. 4, 2002

(54) Confined-flux ferrite structure for circulator/isolator

(76) Inventor: Karen Kocharyan, Somerville, MA (US)

Correspondence Address: Karen Kocharyan, Renaissance Electronics Corporation, 12 Lancaster County Road, Harvard, MA, 01451, US

(21) Appl. No.: 09/827,787

(22) Filed: Apr. 9, 2001

Related U.S. Application Data
(60) Provisional application No. 60/203,865, filed on May 12, 2000.

(51) Int. Cl. H01P 1/32

(52) U.S. Cl. 333/1.1; 333/24.2

(57) ABSTRACT

A ferrite structure for non-reciprocal microwave device such as circulator/isolator. The structure includes one or more composite ferrite bodies, each having at least one region of soft ferrite material and at least one region of hard ferrite material, and at least two ferrous/ferrite plates. The ferrous/ferrite plates are attached to the composite ferrites so as to contribute to the completion of magnetic loop via hard and soft ferrite regions of the composite ferrites. The soft and hard ferrite regions are magnetized in the opposite direction. The range of operation is selected to be between the resonant frequencies of soft and hard ferrite materials. With such setting the hard and soft ferrite regions provide the circulation in the same direction. As compared to the state-of-the art devices, the circulators/isolators made according to the present invention incorporate the confined-flux self-magnetized ferrite structure, thus eliminating the use of conventional magnets. This devices have extended bandwidth, are reliable in operation and inexpensive in production. The structure according to the present invention is very compact, lightweight and broadband.

### CROSS-REFERENCE TO RELATED APPLICATIONS

This application claims the benefit of provisional application No. 60/203,865 filed May 12, 2000.

### BACKGROUND OF THE INVENTION

The present invention relates generally to microwave ferrite devices and, more specifically, to ferrite structures used in those devices to perform non-reciprocal circulation action. Most common ferrite devices are Y-shape junction circulators/isolators. In stripline embodiment, the junction is situated between two flat ferrites and biased externally by the dc magnetic field applied perpendicularly to the ferrites. The Y-junction has three branches symmetrically extending 120 degrees apart from the common central area. In circulators, all three branches are electrically connected to the transmission lines (ports). In isolators, one of the ports is terminated by a matched load (usually a 50 Ohm resistor).

Presently, there are two basic setups for the magnetic field application in the stripline circulators/isolators. First one is a tower-like setup, where the magnets (usually two ones) are attached to the opposite faces of the ferrite structure. This setup implies the use of non-ferrous ground planes to hold the magnets in place, a u-shape ferrous shunt clip to complete the magnetic loop, and the side covers to close the whole structure. The second one is a drum-like setup, where the magnets (usually three ones) are disposed in a common plane with the ferrites, being evenly spaced along the structure's periphery. This setup implies the use of two flat ferrous plates (pole pieces) on the opposite faces of ferrite-magnets setup. These plates are necessary for the completion of magnetic loop. The height of ferrite-junction-ferrite setup and that of magnets in the structure ideally should be the same to provide the simultaneous contact of the ferrites and the magnets with both pole pieces.

The existing circulators/isolators incorporate ferrite structures with either soft or hard ferrites, both exhibiting gyrotropic properties in a magnetized state. The soft ferrites require a biasing dc magnetic field provided by external magnet in order to maintain the magnetized state. Their frequency of natural magnetic resonance (resonance in the absence of external magnetic field) is equal to zero. With the external magnetic field the frequency of magnetic resonance can be tuned in the range from zero to about 20 GHz. Therefore, the soft ferrites are usually used in the relatively low frequency devices. The microwave devices intended for high-frequency applications usually incorporate the hard ferrites. Ferrite materials, such as Sr/Ba hexaferrite ceramic, used in those devices, have the frequency of natural magnetic resonance of about 40 GHz and above. The hard ferrites are permanent magnets with a high remanent magnetization. Therefore, they can be used without applying any external magnetic field, as self-biased ferrites.

The stripline circulators are usually narrow-band devices. The bandwidth here is defined to be a difference between the highest and the lowest frequencies of operation, at which the acceptable insertion loss and the required isolation between the corresponding ports are achieved. If the broadband operation is required, the matching transformers or composite ferrites have to be used (see, for example, U.S. Pat. No. 4,205,281). The composite ferrites are made in such a way that their constituent elements (ferrite puck and rings) are combined in radial direction one outside of the other, to have the last ferrite ring externally encircling the internal portion of the composite. The application of the composite ferrites in the conventional ferrite structures improves the bandwidth performance by providing the required circulation at two or more operation frequencies. This is achieved by selecting the saturation magnetization and the size of the external ferrite determined as a function of the first frequency, equal or nearly equal to the lowest frequency of the pass band. The second ferrite is selected to have the saturation magnetization and the size determined as a function of the second frequency selected to be above the frequency for the first ferrite element. The third and additional ferrite elements may be selected using the same approach (see, for example, U.S Pat. No. 4,496,915). Since the common external magnetic system is used for the composite ferrites, all the constituent ferrite elements in the structure are magnetized in the same direction.

In practice, it is difficult to develop compact and lightweight circulators/isolators operating in a wide frequency range. The application of stronger magnetic fields, the utilization of sophisticated multi-ring ferrite-dielectric assemblies and complicated matching transformers in order to extend the bandwidth and to increase the operation frequency, require more space, add to size, weight and cost. The circulators/isolators are widely used in communication equipment including those used on board of satellite vehicles, in mobile and hand-held terminals. Therefore, increasing the operation frequency and extending the bandwidth while maintaining a small size and weight, are important objectives for the circulators/isolators design.

### BRIEF SUMMARY OF THE INVENTION

The present invention relates to the ferrite structures used in passive broadband microwave devices and, more specifically, in circulators/isolators. The new ferrite structures described in this invention may be implemented with various types of transmission lines, including striplines, microstrips, waveguides, quasi-optical beams, etc. The stripline Y-circulator comprises two composite ferrites, circuit junction, and at least two ferrous plates. Each composite ferrite includes at least two regions. One of the regions is made from a soft ferrite and another one is made from a hard ferrite. The composite ferrite represents a monolithic disk-shape body. The ferrous plates are disposed on the opposite external faces of composite ferrites. The hard and soft ferrite regions of the composite ferrite are the parts of magnetic loop completed via ferrous plates. The direction of magnetization in all hard ferrite regions is the same. The hard and soft ferrite regions are magnetized in the opposite directions. The junction having basically Y-shape, with three branches projecting outward from the periphery of ferrite structure, is situated between the internal faces of composite ferrites. The shape of the junction branches is selected to provide the impedance matching, thereby minimizing the insertion loss and achieving acceptable voltage standing wave ratio (VSWR). The operation bandwidth of the device incorporating this ferrite structure is selected to be between the frequencies of magnetic resonance in soft and hard ferrites.

Thus, the new ferrite structure according to the present invention is a portion of a passive microwave device such as circulator/isolator, where the RF processes are developed. The composite ferrites and the ferrous plates in the structure are disposed symmetrically on each side of the junction in parallel relationship with each other. The composite ferrites, each comprising at least two regions, the soft and the hard ones, have different frequencies of magnetic resonance. Both regions of ferrite structure have the gyrotropic properties, while the hard ferrite region possesses also the permanent magnetic properties. The magnetic flux outgoing from the hard ferrite regions creates a loop through the ferrous plates, soft ferrite regions and the junction. In this loop the direction of magnetic flux within the soft ferrite regions is opposite to that within the hard ferrite regions.

It is an object of the present invention to have a structure with internally created DC magnetic flux, without application of any external magnetic field.

It is a further object of the present invention to have a structure wherein the magnetic flux creation area would be a part of the region where the circulation process takes place, by this eliminating an extra space for external magnets.

It is a further object of the present invention to have a structure that provides the broadband operation including the most difficult range of frequencies to achieve with the conventional devices (approximately from 20 to 40 GHz).

It is the advantage of the present invention to have a ferrite structure for the devices such as circulator/isolator that provides very wide frequency range, maximum compactness, and minimum weight with the low labor expenses and material cost.

### BRIEF DESCRIPTION OF THE SEVERAL VIEWS OF THE DRAWING

FIG. 1 shows the side view in cross section of the existing ferrite structure drum-like setup. Magnetic loops and the direction of magnetic flux are also shown.

FIG. 2 shows the bottom view of ferrite structure according to FIG. 1 with the bottom ferrous plate removed (for clarity), where arrows show the direction of circulation.

FIG. 3 shows the side view in cross section of the preferred embodiment of structure according to the present invention. Magnetic loops and the direction of magnetic flux are also shown.

FIG. 4 shows the bottom view of ferrite structure according to FIG. 3 with the bottom ferrous plate removed (for clarity), where arrows show the direction of circulation.

FIG. 5 shows the graph of anisotropic splitting factor versus frequency in the structure according to the present invention.

FIG. 6 shows the embodiment of the present invention for the use in devices having wave guide transmission lines.

FIG. 7 shows the embodiment of the present invention for the use in devices having quasi-optical transmission lines.

FIG. 8 shows experimentally measured scattering parameters versus frequency in the range from 50 MHz to 20 GHz for a stripline circulator incorporating ferrite structure according to the present invention.

### DETAILED DESCRIPTION OF THE INVENTION

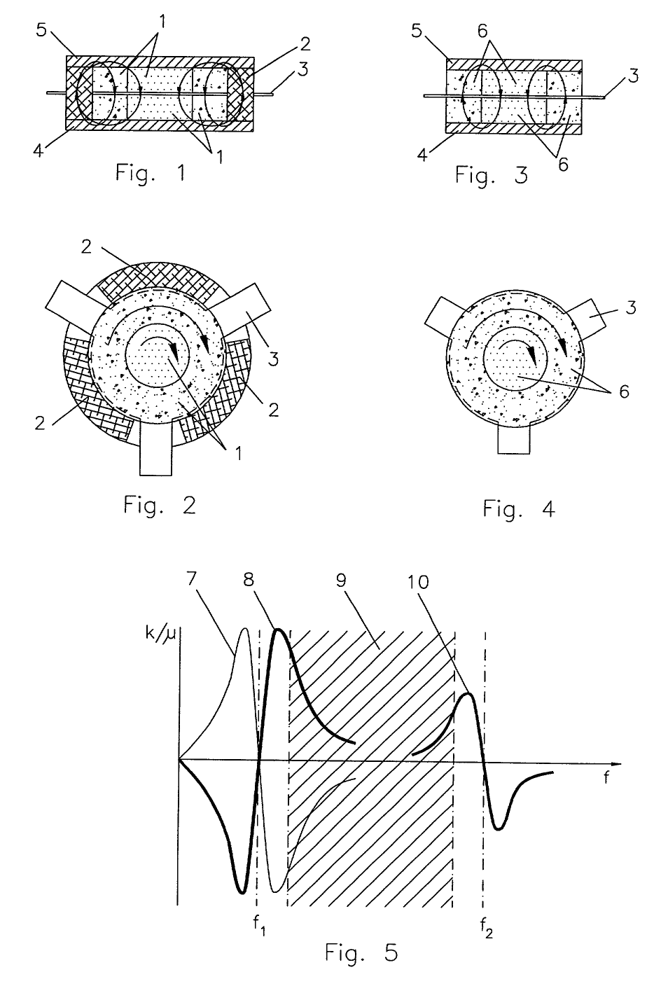

For the clarity of the description, it is given thereafter in comparison with the state-of-the art drum-like setup ferrite structure. Referring to FIG. 1 and FIG. 2 the existing ferrite structure comprises two ferrites 1, a junction 3, and two ferrous plates 4, 5. Each of the ferrites 1 can be made either of only one ferrite material or include several regions of different ferrite materials representing a composite body (two-region composite ferrites are shown, each region having different hatch pattern). In the existing ferrite structures the DC magnetic field is created by three external magnets 2 situated on the periphery of structure. The magnetic loop and the direction of magnetic flux are also shown in FIG. 1. The ferrous plates 4, 5 are extended beyond the composite ferrites to cover the magnets 2 in order to complete the magnetic loop. As one can see in FIG. 1, the direction of magnetic flux in all regions of ferrites 1 is the same. This implies the use of the same kind of ferrite materials, either soft or hard ones, in all regions of composite ferrite to produce the same direction of circulation (as shown by arrows in FIG. 2). This condition should be maintained in all existing ferrite structures in order to operate. FIG. 2 shows also that the magnets in the existing structures are away from the area where the circulation takes place.

Before the ferrite structure according to the present invention will be described, it is expedient to consider briefly the theory of circulation. The circulation action in ferrite devices, such as circulators/isolators, results from the gyrotropy of ferrite materials. The gyrotropy follows from Polder's tensor of magnetic permeability:

$$\{ μ \} = \vert \begin{matrix}μ & iK & 0 \\ - iK & μ & 0 \\ 0 & 0 & 1\end{matrix} \vert \qquad ( 1 )$$

Where:

μ=[ƒᵣₑₛ(ƒᵣₑₛ+ƒ_{M})−ƒ²]/(ƒᵣₑₛ²−ƒ²) (2)

K=ƒ_{M}ƒ/(ƒᵣₑₛ²−ƒ²) (3)

ƒᵣₑₛ=γ(H_{A}+H₀)/2π (4)

Here H₀ is the external magnetic field, H_{A} is the effective field of magnetic anisotropy,ƒ is the operation frequency,ƒᵣₑₛ is the frequency of magnetic resonance,ƒ_{M}=2γM and M is the saturation magnetization. Circular components of the magnetic permeability that follow from (1) are given as:

μ_{±}=(ƒᵣₑₛ+ƒ_{M}±ƒ)/(ƒᵣₑₛ±ƒ) (5)

These components correspond to the clockwise and counter-clockwise rotating waves, respectively. The interference of counter-propagating waves within ferrite element, such as discs or rings used in circulators/isolators, leads to the development of standing waves known also as the resonance modes of element.

The azimuth of resonant mode with respect to the input port depends on the magnetic state of ferrite element and is given by the anisotropic splitting factor K/μ. According to (3), the splitting factor increases as the operation frequency approaches the resonance and changes the sign as the frequency crosses the resonance (see also FIG. 5). The inversion of magnetization changes the sign of anisotropic splitting factor. In a demagnetized state the anisotropic splitting factor is equal to zero and there is no rotation of modes with respect to the input port. The magnetization of ferrite element in the direction perpendicular to the plane of ferrite element introduces azimuthal rotation of a mode. This rotation is used in the circulators/isolators to couple the input port with one of the output ports and to isolate it from the another one.

Referring to FIG. 3 and FIG. 4 the ferrite structure according to the present invention comprises two ferrites 6, a junction 3, and two ferrous plates 4, 5. Each of the ferrites 6 represents a composite body including first and second gyromagnetic elements (shown with different hatch patterns). One of those elements is made from the soft ferrite and another one is from the hard ferrite. Both ferrite elements, a puck and a ring, are disposed concentrically, forming, as clearly shown in FIG. 4, a round disk-like structure 6. Which material (soft or hard) is disposed within this disk-like structure as a puck, and which one is disposed as a ring, depends on the specifications of the particular device and may be chosen by a designer.

The junction 3 is disposed between the composite ferrites 6. The ferrous plates 4, 5 are disposed on the outside faces of the composite ferrites 6. The junction 3, having Y-like shape, includes a central area disposed substantially within the outside diameter of the ferrites 6, and three branches projecting outwardly from the central area by 120 degrees apart.

In operation, the permanent magnet properties of hard ferrite material create the flux in the ferrite structure. The magnetic loop, shown in FIG. 3, completes via the ferrous plates 4, 5. It is seen that direction of the magnetic flux (shown in FIG. 3 by the arrows) in the soft ferrite material is opposite to that in the hard ferrite material. As already was mentioned above, the sense of circulation depends on the direction of magnetization and the sign of frequency offset (ƒ−ƒᵣₑₛ). In soft ferrites the internal field of anisotropy is very small. Therefore, the frequency of resonance can be set to be at low microwave frequencies. The hard ferrites are characterized by very high anisotropy with the magnetic resonance observed at the frequencies above 40 GHz. In the devices according to the present invention, the operation range is selected to be between the resonance in soft ferrite and the resonance in hard ferrite. With such setting the operation range is situated above the resonance in soft ferrite material (positive frequency offset) and below the resonance in hard ferrite material (negative frequency offset).

If the external source of magnetization (as in the existing ferrite structures) was used, the magnetization of hard and soft ferrite materials would be in the same direction. With different signs of frequency offset the circulation in soft and hard ferrite material regions would be in opposite directions, thus canceling the overall circulation effect. In the ferrite structure according to the present invention, however, the soft and hard ferrite regions of the composite ferrites 6 are magnetized in opposite directions (see FIG. 3). Therefore, the sense of rotation in both ferrite elements will be the same (as shown by arrows in FIG. 4) in the entire frequency range between the resonant frequencies in soft and hard ferrite materials. This will lead to the significant extension of bandwidth where the useful circulation action can be realized.

In order to achieve the operational condition, the structure according to the present invention should be temporary exposed to an external magnetic field. This will permanently magnetize the hard ferrite material. Magnetic flux originating in the magnetized hard ferrite material will be confined within the closed magnetic loop. In order to minimize the losses, the soft and hard ferrite materials in the structure have to be maintained close to the magnetically saturated state. This can be obtained by selecting the size and magnetic parameters of the ferrite regions according to the equation:

M_{hard}×S_{hard}≧M_{soft}×S_{soft} (6)

where M and S are the saturation magnetization and the area of corresponding ferrite material regions, respectively. Since the demagnetizing factor for a complete magnetic loop is very small, the structure will maintain the state of magnetic saturation in the absence of external magnetic field.

To illustrate the operation of the device according to the present invention, we will use the graph shown on FIG. 5. The curves 7 and 10 represent the frequency dependence of anisotropic splitting factor for the soft and hard ferrite materials, respectively. The resonance frequency in a soft ferrite material is shown by the line f1 and that for the hard ferrite material-by line f2. The hatched area 9 represents the operation range. As shown in FIG. 5, the soft ferrite material in the ferrite structure according to the present invention operates in above the resonance mode (ƒ−ƒᵣₑₛ>0), while the hard ferrite material operates in below the resonance mode (ƒ−ƒᵣₑₛ>0). With the setup shown in FIG. 3, 4, the curve 7 for the soft ferrite has to be inverted into the mirror image (curve 8) because of the opposite direction of magnetization as compared with that in the hard ferrite material. Thus, in the operation range (hatched area 9) both curve 8 and curve 10 will be in the same circulation domain (positive, as shown in FIG. 5). In theory, the operation range extends from the resonance in the soft ferrite material throughout to the resonance in the hard ferrite material. In practice, the range will be slightly less (as shown in FIG. 5) since the narrow areas around the resonance should be avoided in order to diminish the losses.

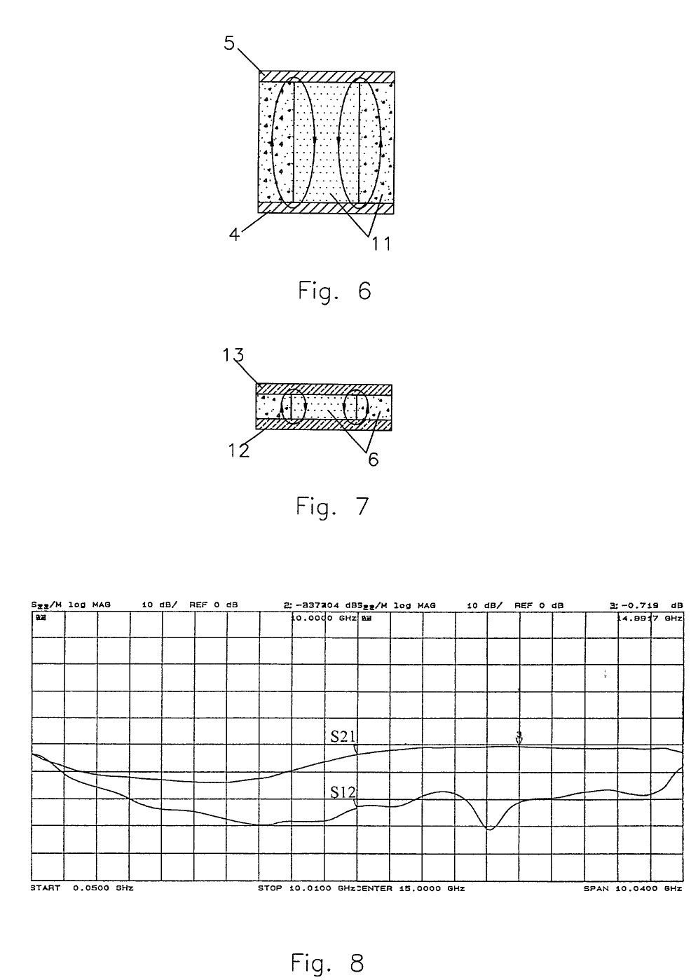

Referring to FIG. 6, the embodiment including the composite ferrite body 11 and two ferrous plates 4, 5 is also within the scope of the present invention. The composite ferrite 11 consists of the same materials and functions identically to the ferrite 6 shown in FIG. 3 and FIG. 4. The plates 4, 5 are the same as shown in FIG. 3. The ferrite structure in this embodiment is usually an elongated cylinder, called a post, but the principle of operation is the same as was described above for a stripline circulator/isolator. The only difference is that in this structure there is no junction, and there is only one composite ferrite (instead of two). In devices having waveguide transmission lines, wherein the embodiment shown in FIG. 6 can be implemented, neither a junction nor a second ferrite are used.

Another embodiment shown in FIG. 7 is also within the scope of the present invention. In this embodiment the plates 12, 13 are made of ferrimagnetic material, and the composite ferrite body 6 is the same as shown in FIGS. 3, 4 and described above. This embodiment can be implemented in devices having quasi-optical transmission lines.

FIG. 8 shows the experimental data (scattering parameters versus frequency) for a compact circulator (0.5″×0.5″×0.2″) incorporating ferrite structure according to the present invention. This device provides the circulation with insertion loss below 1 dB, isolation more than 17 dB and VSWR below −15 dB in a wide spectral range spanning from 12 to 18 GHz. Moreover, one can see that the circulation (the splitting between S₁₂ an S₂₁) extends further toward lower and higher frequencies, indicating the potential for further bandwidth extension.

Thus, the ferrite structure according to the present invention is capable to operate in a broad band range of frequencies maintaining a self-confined magnetic flux without using any external magnet. By eliminating the external magnets and, accordingly, their supporting elements, the device incorporates fewer parts, becomes more reliable in operation and less labor consuming in production. Because of that, the ferrite structure in accordance to the present invention can be implemented in a simple, very compact, lightweight and inexpensive device. Such a device will also demonstrate better bandwidth performance as compared with the conventional devices.

While the stripline embodiment of the invention has been described in details above, it is clear that there are variations and modifications to this disclosure here and above which will be readily apparent to one of the ordinary skills in the art. For example, the composite ferrite may have triangular or other symmetrical shape. The hard-soft ferrite combination, as described above and shown in FIGS. 6, 7 can also be implemented in other non-reciprocal devices such as the ones used in the quasi-optical and wave guide transmission lines. To the extent that such variations and modifications of present disclosure of ferrite structure for circulator/isolator, wherein: a) the soft ferrite element is disposed with respect to the hard ferrite so as to contribute to the completion of magnetic loop, b) the soft and hard ferrite regions have opposite directions of magnetization, and c) the operation frequency is selected to be between the resonance frequencies of soft and hard ferrite materials, such are deemed within the scope of the present invention.

Having described my invention, I claim:

1. A confined-flux ferrite structure for circulator/isolator comprising
a first composite body of the gyromagnetic material;
a second composite body of the gyromagnetic material;
at least two plates of ferromagnetic material;
a junction of electrically conductive material, wherein said junction is disposed between and against said first and said second composite bodies, said plates are disposed each outside and against said composite bodies, each of said composite bodies having at least one region of soft ferrite material with the first resonant frequency and one region of hard ferrite material with the second resonant frequency, said hard ferrite material region is magnetized and disposed relative to the said soft ferrite material region so as to complete the magnetic loop in said structure, and operation bandwidth of said circulator/isolator is selected to be between said first and said second resonant frequencies.

2. A structure as recited in claim 1, wherein said first and said second composite bodies each having disk-like shape with one of said ferrite material regions is disposed centrally as a puck, and at least another one of said ferrite material regions is disposed as a ring concentrically around said puck.

3. A structure as recited in claim 1, wherein said first composite body of gyromagnetic material and said second composite body of gyromagnetic material and also said two plates of ferromagnetic material are symmetrically disposed about said junction in parallel relationship to and in contact with each other.

4. A structure as recited in claim 1, wherein said junction of electrically conductive material having Y-like shape with central portion and three branches, said central portion disposed concentrically to and basically within said composite body area, and said three branches outgoing 120 degrees apart from said central portion.

5. A structure as recited in claim 1, wherein said two plates of ferromagnetic material are portions of a device said ferrite structure build in.

6. A structure as recited in claim 1, wherein said soft ferrite material region and said hard ferrite material region having opposite directions of magnetization.

7. A confined-flux ferrite structure for circulator/isolator, comprising
at least one composite body of gyromagnetic material;
at least two plates of ferromagnetic material, wherein said composite body having at least one region of soft ferrite material with first resonant frequency and at least one region of hard ferrite material with second resonant frequency, said regions disposed concentrically in the same plane and in between said plates of ferromagnetic material, said hard ferrite material region is magnetized and disposed relative to said soft ferrite material region so as to complete the magnetic loop, said regions having opposite direction of magnetization, operation frequency is adapted to be between said first and said second resonant frequencies, and said structure is adapted to be used in devices with waveguide transmission lines.

8. A confined-flux ferrite structure for circulator/isolator, comprising
at least one composite body of gyromagnetic material;
at least two plates of ferrimagnetic material, wherein said composite body having at least one region of soft ferrite material with first resonant frequency and at least one region of hard ferrite material with second resonant frequency, both said regions disposed in the same plane and in between said plates of ferrimagnetic material, said hard ferrite material region is magnetized and disposed relative to said soft ferrite material region so as to complete the magnetic loop, said regions having opposite direction of magnetization, operation frequency is adapted to be between said first and said second resonant frequencies, and said structure is adapted to be used in devices having quasi-optical transmission lines.
